(19) United States
(12) Patent Application Publication
(10) Pub. No.: US 2017/0150018 A1
(43) Pub. Date: May 25, 2017

(54) CAMERA POSITIONING AND ORIENTING APPARATUS

(71) Applicant: Eugene H. LUOMA, Duluth, MN (US)

(72) Inventor: Eugene H. LUOMA, Duluth, MN (US)

(21) Appl. No.: 15/361,349

(22) Filed: Nov. 25, 2016

Related U.S. Application Data
(60) Provisional application No. 62/259,333, filed on Nov. 24, 2015.

(51) Int. Cl. H04N 5/225; F16M 11/28; F16M 11/38; F16M 13/02; F16M 11/20

(52) U.S. Cl. CPC H04N 5/2253; F16M 13/02; F16M 11/2092; F16M 11/38; F16M 11/28; F16M 2200/063; F16M 2200/068; F16M 2200/025

(57) ABSTRACT

A camera stand comprises a base portion that may seat on or be suitably anchored on a floor surface, boat, dock, table, rail, vehicle, or other support structure. A horizontally and vertically adjustable linkage extends from the base portion and has the camera positioned at an end of the linkage. Means are provided for keeping the camera at a specific angle from horizontal as the adjustable linkage moves the camera about. Means are provided to provide joints in the linkage that have suitable resistance to unintended movement by gravity, wind or other forces and for which resistance to unintended movement is readily adjustable.

### CROSS-REFERENCE TO RELATED APPLICATION

This application claims the priority to U.S. Provisional Application No. 62/259,333 with a filing date of Nov. 24, 2015. Said application is incorporated herein in its entirety.

### BACKGROUND

The present disclosure relates to apparatus that may be used, for example, to place and hold an object, such as a camera in a wide variety of locations and orientations in a three dimensional space. The apparatus provides multiple degrees for freedom for positioning, orienting and holding the camera. Degrees of freedom in three dimensional spaces may be described with reference to a Cartesian coordinate system. It is customary to describe the Cartesian coordinate system by making reference to three orthogonal axes designated X, Y and Z. The term “degree of freedom” in this context means the ability of a body to translate along one of the three orthogonal X, Y, or Z axes shown (a translational degree of freedom) or to rotate about one of these three orthogonal axes (a rotational degree of freedom).

Such known devices are complicated, expensive, heavy, and not conducive to general consumer use, particularly where such devices are used for extending cameras outwardly, such as in a cantilevered manner, and then moving the cameras upwardly and downwardly. Additionally, the ranges of motion such devices provide to cameras may be limited by joints that have incremental adjustment positions. Moreover, such devices have not been specifically adapted for modern lightweight high definition video cameras

### SUMMARY OF THE INVENTION

In embodiments a camera stand comprises a base portion that may seat on or be suitably anchored on a floor surface, boat, dock, table, rail, vehicle, or other support structure. A horizontally and vertically adjustable linkage extends from the base portion and has the camera positioned at an end of the linkage. Means may be provided for keeping the camera at a specific angle from horizontal as the adjustable linkage moves the camera about. Means may be provided to provide joints in the linkage that have suitable resistance to unintended movement by gravity, wind or other forces and for which resistance to unintended movement is readily adjustable.

In embodiments, a camera stand has an upright proximal link portion that is rotatable about the base portion at a first pivoting base joint, the joint providing pivoting movement at least about a vertical axis. The proximal link portion forms part of a four-bar linkage, and have two vertically separated pivoting joints with horizontal axis from which two elongate control arms extend. The two elongate control arms may extend substantially parallel from the proximal link portion to a distal link portion and connect to the distal link portion at two additional pivoting joints having horizontal axis. Thus, the proximal link portion, the two control arms, and the distal link portion form a four bar linkage. The distal link portion may have tube holder portion with a lumen extending vertically, a tube positioned in the tube holder and a camera mount at an end of the tube. The tube movable axially and rotatable within the tube holder. The tube holder portion may have a clamp to adjustably clamp the tube in place. The clamp may have a threaded member with a graspable handle for rotation of a threaded member.

The two joints on the proximal link portion may be equally spaced as the two joints on the distal link portion. Moreover, a geometric line extending through the two joints on the proximal link portion may be parallel to a line extending through the two joints on the distal link portion thereby shaping the four bar linkage as a parallelogram that will keep an axis of the proximal joint portion parallel to an axis of the distal link member.

In embodiments, the two elongate control arms may be tubes or rods and formed of aluminum, other metals, carbon fiber, fiberglass, polymers, reinforced polymers and other materials. In embodiments, such tubes or rods may be ⅜ in diameter to 1½ inch in diameter. In embodiments, the linkage may extend 2.5 to 7 feet outwardly from the base portion. In embodiments 2 feet to 6 outwardly from the base portion. In embodiments each of the control arms have a length and the tube has a length within 25% of the length of each of the control arms.

In embodiments of the invention, with regard to the base joint and the two joints on the proximal link portion and the two joints on the distal link member, each joint comprises at least one pair of cooperating joint components movable with respect to each other and defining the joint. Each pair of cooperating joint components with cooperating slidingly engaged joint surfaces. In embodiments, the cooperating joint surfaces are parallel, such as planar surfaces or partial spherical surfaces. The parallel cooperating surfaces and may have a high coefficient of friction with respect to each other that may be adjusted by varying clamping pressure between the respective surfaces. In embodiments at least one of pair of cooperating components comprises a component formed by overmolding or otherwise covering an exterior surface of one of the joint components with a polymer covering. The overmolded polymer may chemically adhere or be mechanically locked onto the base joint component. Polymers such as thermoplastic elastomers and more rigid polymers, such as polyethylenes, are suitable. In embodiments, the polymer has a durometer of 65 to 75 on the Shore A scale. In embodiments, the polymer has a durometer of 60 to 80 on the Shore A scale. The base joint component upon which the polymer overmolding is added may be formed of aluminum, steel, rigid polymers, or other structurally strong materials. In embodiments, the clamping force of the cooperating joint surfaces may be adjustably controlled by threaded members with manually graspable handles. In embodiments, the joints with an overmolded cooperating slidingly engaged joint surface provide easy adjustability for providing suitable resistance to sliding to maintain a camera stand with an extended arm against movement caused by gravity or other forces while still allowing each manual manipulation of the adjustable arm.

A feature and advantage of the invention is that a four bar linkage is pivotally attached to a base portion, a tube holder secures a vertical tube, a camera mount is positioned on the vertical tube, at least one joint of the four bar linkage has an overmolded cooperating joint component to provide enhanced resistance of pivoting.

In embodiments of the invention, the stand is in combination with a camera weighing less than 7 ounces and having a maximum dimension of 4 inches. In embodiments of the invention, the stand is in combination with a camera weighing less than 5 ounces and having a maximum dimension of 3½ inches.

### BRIEF DESCRIPTION OF THE FIGURES

FIG. 1A is an isometric view of a stand that may be used to position, orient and hold an object, such as a camera, in a wide variety of locations and orientations within a space having three dimensions.

FIG. 1B is an elevational view of a folded camera stand according to embodiments of the invention.

FIG. 1C is a perspective view of a tripod adaptor as part of the stand of FIG. 1B.

FIG. 1D is a cross sectional view of the tripod adaptor of FIG. 1C.

FIG. 2 is an exploded perspective view further illustrating a distal assembly of the stand shown in FIG. 1.

FIG. 3A is an exploded perspective view further illustrating a base assembly of the stand shown in FIG. 1.

FIG. 3B is an enlarged cross-sectional view showing the base assembly of FIG. 3A in an assembled state.

FIG. 4 is an isometric view of a stand that may be used to position, orient and hold an object, such as a camera, in a wide variety of locations and orientations within a space having three dimensions.

FIG. 5 is an exploded perspective view further illustrating a distal assembly of the stand shown in FIG. 4.

FIG. 6A and FIG. 6B are perspective views showing the distal assembly of FIG. 5 in two different states.

FIG. 7 is an isometric view of a stand that may be used to position, orient and hold an object, such as a camera, in a wide variety of locations and orientations within a space having three dimensions.

FIG. 8 is an exploded perspective view further illustrating a distal assembly of the stand shown in FIG. 7.

FIG. 9A is an exploded perspective view showing a tube holder and a flange of a distal assembly arranged in a first indexed orientation.

FIG. 9B is an exploded perspective view showing a tube holder and a flange of a distal assembly arranged in a second indexed orientation.

FIG. 10 is a perspective view of a distal link portion with an adjustment member and camera mount attached thereto.

FIG. 11 is a perspective view of a joint component with an overmolded portion.

FIG. 12 is a perspective view of a joint component.

### DETAILED DESCRIPTION

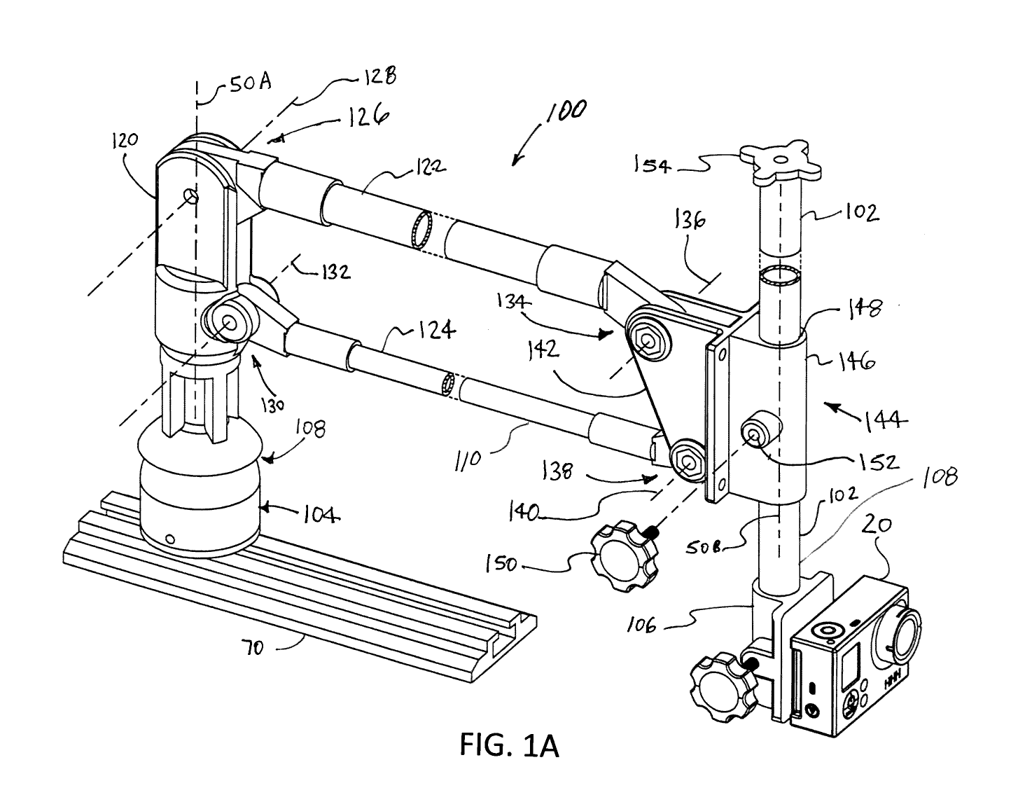

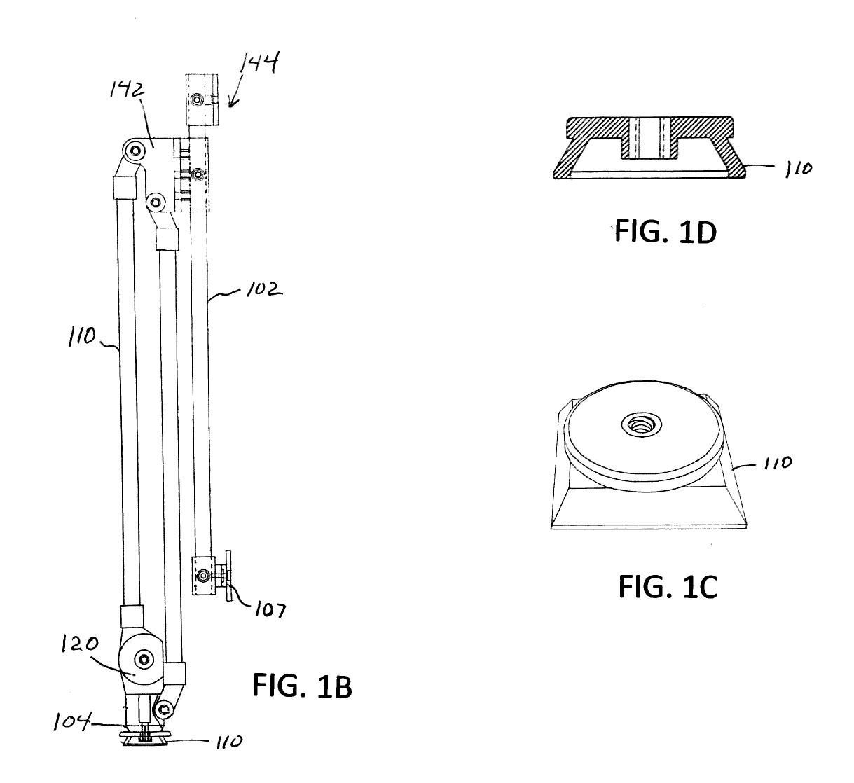

FIGS. 1A and 1B are views of camera stand 100 that may be used to position, orient and hold a camera 20, in a wide variety of locations and orientations within a space having three dimensions. A base portion 104 has a linkage 106 with a camera 20 attached to a distal portion 108 of the linkage at a camera mount 107. In the embodiment of FIG. 1, stand 100 includes a base assembly 104 that is attached to a mounting rail 70. As shown in FIG. 1, the base portion may be configured as a base assembly 104 and may be fixed to mounting rail 70 at various positions along a generally T-shaped slot in the mounting rail 70. In the embodiment of FIG. 1A, the base assembly 104 includes a pivoting joint 108 that provides three rotational degrees of freedom. The base portion may have other configurations as shown in FIG. 1B with a tripod adaptor 110. The pivoting movement provided by the pivoting joint 108 can be used to alter the position of the linkage and the attached camera.

In embodiments, the camera stand linkage 106 has a four bar linkage 110 connecting to the base portion 104. The four bar linkage 110 having a proximal link portion 120 that may be adjustably rotated about an axis 50A. Proximal link portion 120 supports a first control arm 122 and a second control arm 124, addition links of the four bar linkage. The proximal end of the first control arm 122 is pivotally coupled to the proximal link portion 120 at a first linkage joint 126. The proximal end of the second control arm 124 is pivotally coupled to the proximal link portion 120 at a second linkage joint 130. The first linkage joint 126 allows first control arm 122 to pivot about a first linkage joint axis 128. The second linkage joint 130 allows second control arm 124 to pivot about a second linkage joint axis 132. In the embodiment of FIGS. 1A and 1B, second linkage joint 130 may be selectively tightened so that friction prevents rotation of second control arm 124 and first control arm 122. In embodiments the control arms are parallel and the same length as measured from joint to joint.

The first control arm 122 and the second control arm 124 support a distal link portion 142 of the stand 100. The proximal link portion is the fourth link of the four bar linkage 106. The distal end of the first control arm 122 is pivotally coupled to the distal link portion 142 at a third linkage joint 134. The distal end of the second control arm 124 is pivotally coupled to the distal link portion 142 at a fourth linkage joint 138. The third linkage joint 134 allows relative rotation between the first control arm 122 and the distal link portion 142. Relative rotation between the first control arm 122 and the distal link portion 142 occurs about a third linkage joint axis 136. The fourth linkage joint 138 allows relative rotation between the second control arm 124 and the distal link portion 142. Relative rotation between the second control arm 124 and the distal link portion 142 occurs about a fourth linkage joint axis 140.

With reference to FIGS. 1A and 1B, it will be appreciated that the position of the camera 20 can be changed by raising and lowering the distal ends of the control arms. The proximal ends of the control arms pivot relative to proximal link portion 120 when the distal ends of the control arms are raised and lowered. In some useful embodiments, first control arm 122, second control arm 124, proximal link portion 120 and distal link portion 142 cooperate to form a parallelogram linkage. When this is the case, a line through the first linkage joint axis 128 and the second linkage joint axis 132 remains generally parallel to a line through the third linkage joint axis 136 and the fourth linkage joint axis 140 as first control arm 122 and second control arm 124 rotate relative to proximal link portion 120 and distal link portion 142.

In the embodiment of FIGS. 1A and 1B, stand 100 includes a distal assembly 144 that provides additional degrees of freedom for positioning and orienting the camera 20. The distal assembly 144 of FIGS. 1A and 1B includes the distal link portion 142, an adjustment tube 102 and a tube holder portion 146. In the embodiment of FIGS. 1A and 1B, the tube holder portion 146 is fixed to the distal link portion 142, for example, using screws. The tube holder 146 defines a lumen 148 that is dimensioned to receive the adjustment tube 102. In FIGS. 1A and 1B, the adjustment tube 102 can be seen extending through lumen 148 of tube holder 146.

In the embodiment of FIGS. 1A and 1B, the adjustment tube 102 supports a mounting bracket 106, the mounting bracket 106 supports a camera 20. Stand 100 can be used to place and support the camera 20 in a wide variety of locations and orientations. For example, the camera 20 can be rotated by rotating the adjustment tube 102 about an axis 50B. A knob 154 is fixed to one end of adjustment tube 102. The knob 154 may be grasped in the hand when rotating the adjustment tube 102.

In the embodiment of FIGS. 1A and 1B, the adjustment tube 102 is slidingly received in the lumen 148 defined by the tube holder 146. The sliding engagement between the adjustment tube 102 and the tube holder 146 provides a translational degree of freedom. Accordingly, the adjustment tube 102 can slide relative to the tube holder 146 in a direction parallel to its longitudinal axis. The sliding engagement between the adjustment tube 102 and the tube holder 146 also provides a rotational degree of freedom. Accordingly, the adjustment tube 102 can rotate relative to the tube holder 146 about the longitudinal axis of the adjustment tube 102.

Distal assembly 144 includes a thumb screw 150 that may be used to selectively fix the adjustment tube 102 in a desired position. The thumb screw 150 is received in a threaded hole 152 of the tube holder 146. A position retaining force can be applied to the adjustment tube 102 by rotating the thumb screw so that it's distal end presses against the adjustment tube 102. When the thumb screw 150 is loosened, and not applying a fixing force to adjustment tube 102, the adjustment tube will be free to slide and rotate relative to the tube holder 146.

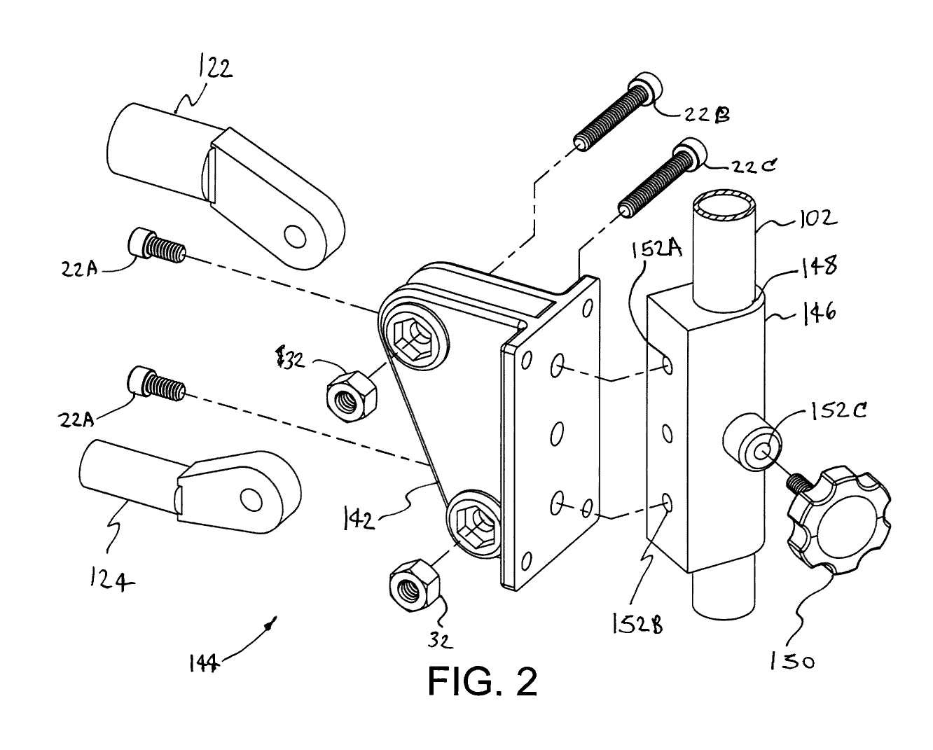

FIG. 2 is an exploded perspective view further illustrating the distal assembly 144 of the stand shown in the previous figures. In the embodiment of FIG. 2, the tube holder portion 146 is fixed to the distal link portion 142 with two screws 22A. The tube holder portion 146 includes two threaded holes 152A, 152B that are dimensioned to receive the screws 22.

The distal link portion 142 of the distal assembly 144 is pivotally coupled to a distal end of the first control arm 122 and a distal portion of the second control arm 124. In the embodiment of FIG. 2, the distal portion of the first control arm 122 is pivotally coupled to the distal link portion 142 using a screw 22B that mates with a nut 32. The distal portion of the second control arm 124 is pivotally coupled to the distal link portion 142 using another screw 22C that mates with a nut 32 in the embodiment of FIG. 2.

In the embodiment of FIG. 2, the adjustment tube 102 is slidingly received in the lumen 148 defined by the tube holder 146. The sliding engagement between the adjustment tube 102 and the tube holder 146 provides a translational degree of freedom. Accordingly, the adjustment tube 102 can slide relative to the tube holder 146 in a direction parallel to its longitudinal axis. The sliding engagement between the adjustment tube 102 and the tube holder 146 also provides a rotational degree of freedom. Accordingly, the adjustment tube 102 can rotate relative to the tube holder 146 about the longitudinal axis of the adjustment tube 102.

Distal assembly 144 includes a thumb screw 150 that may be used to selectively fix the adjustment tube 102 in a desired position. The thumb screw 150 is received in a threaded hole 152C of the tube holder 146. A position retaining force can be applied to the adjustment tube 102 by rotating the thumb screw so that it's distal end presses against the adjustment tube 102. When the thumb screw 150 is loosened, and not applying a fixing force to adjustment tube 102, the adjustment tube will be free to slide and rotate relative to the tube holder 146.

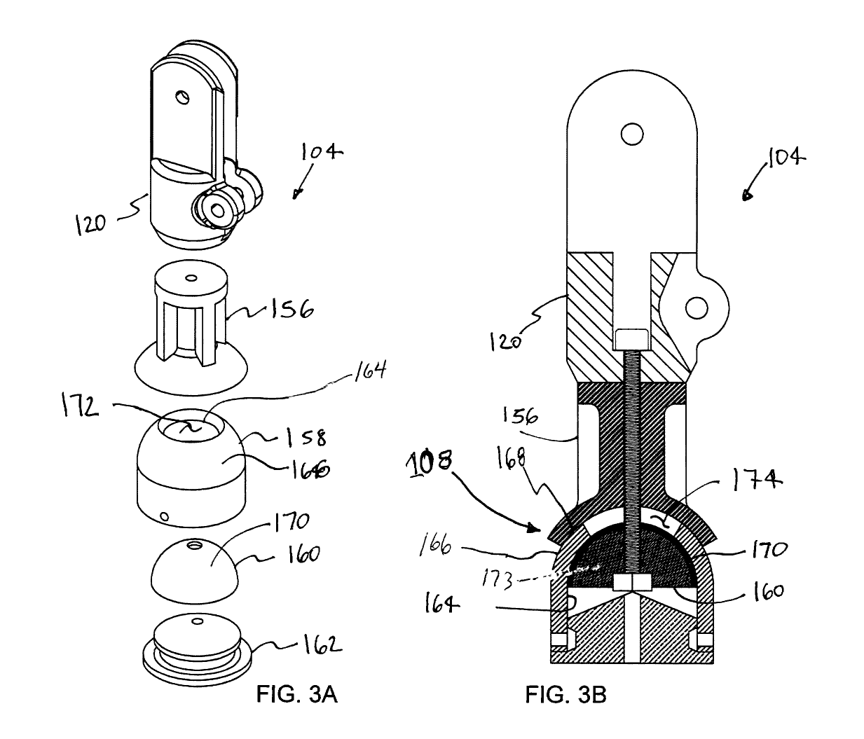

FIG. 3A is an exploded perspective view of the base assembly 104 of the stand shown in FIG. 1A. FIG. 3B is an enlarged cross-sectional view showing the base assembly 104 in an assembled state.

The base assembly 104 of FIGS. 3A and 3B includes a proximal link portion 120, a column member 156, a dome member 158, a core member 160, and a mounting base 162. The dome member 158 of the base assembly has a first inner surface 164 and a first outer surface 166. In the embodiment of FIGS. 3A and 3B, the first inner surface 164 and the first outer surface 166 both have a generally hemispherical shape. The first inner surface 164 of the dome member 158 defines a cavity 172.

The core member 160 is received in the cavity 172 defined by the first inner surface 164 of the dome member 158. The core member 160 has a base joint component 173, a second outer polymer covering 170 having a generally hemispherical shape. The polymer covering 170 may be overmolded into the base joint 173. In the cross-sectional view of FIG. 3B, the first inner surface 164 of the dome member 158 can be seen contacting the polymer covering 170 of the core member 160. The polymer overmolded covering 170 may be various polymers. In embodiments polymers having a Shore A scale durometer of 65-75 have proven satisfactory for providing resistance to an unintended movement of the joint 108.

The column member 156 includes a second inner surface 168 that defines a depression 174. A portion of the dome member 158 is received in the depression 174 defined by the second interior surface of the column member 156. In the cross-sectional view of FIG. 3B, the first outer surface 166 of the dome member 158 can be seen contacting the second inner surface 168 of the column member 156.

In the embodiment of FIGS. 3A and 3B, the base assembly 104 includes a pivoting joint 108 that provides three rotational degrees of freedom. The pivoting movement provided by the pivoting joint 108 can be used to alter the position and orientation of an object, such as a camera, that is supported by the base assembly 104. In the embodiment of FIGS. 3A and 3B, pivoting movement is provided as the first inner surface 164 of the dome member 158 slides along the second outer surface 170 of the core member 160 and the first outer surface 166 of the dome member 158 slides along the second inner surface 168 of the column member 156.

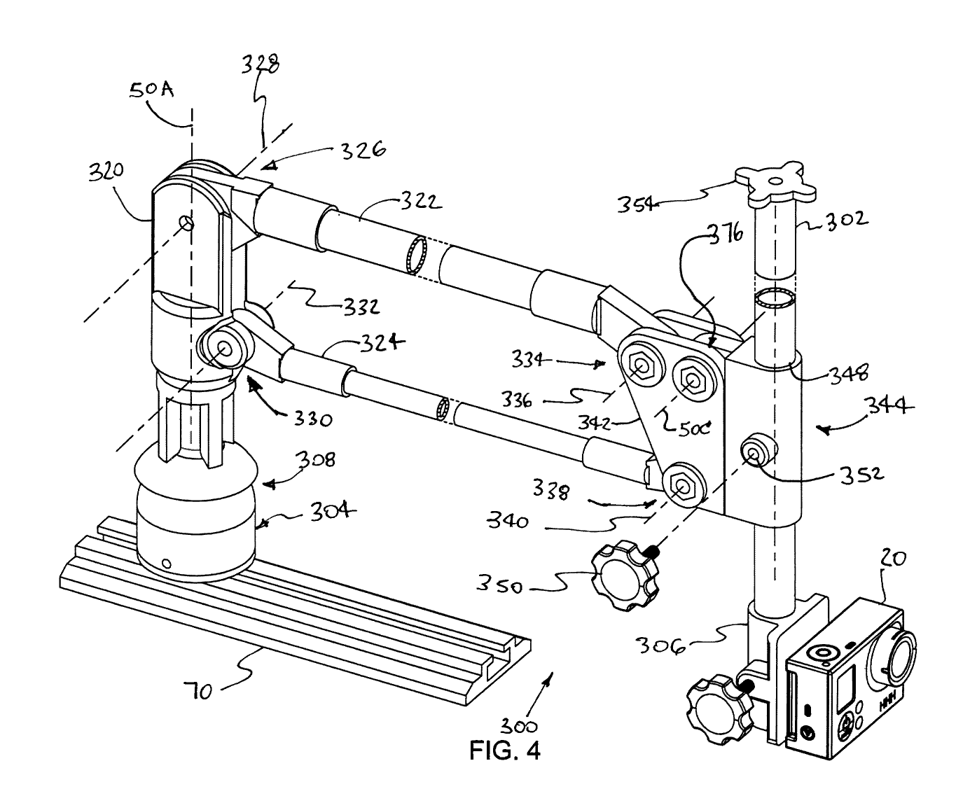

FIG. 4 is an isometric view of a stand 300 that may be used to place and hold a camera 20 in a wide variety of locations and orientations within a space having three dimensions. In the embodiment of FIG. 4, stand 300 includes a base assembly 304 that is fixed to a mounting rail 70. In some useful embodiments, base assembly 304 may be fixed to mounting rail 70 at various positions along a generally T-shaped slot in the mounting rail 70. In the embodiment of FIG. 4, the base assembly 304 includes a pivoting joint 308 that provides three rotational degrees of freedom. The pivoting movement provided by the pivoting joint 308 can be used to alter the position and orientation of the camera 20.

The base assembly 304 includes a proximal link portion 320 that may be selectively rotated about an axis 50A. Proximal link portion 320 supports a first control arm 322 and a second control arm 324 of the stand 300. The proximal end of the first control arm 322 is pivotally coupled to the proximal link portion 320 at a first linkage joint 326. The proximal end of the second control arm 324 is pivotally coupled to the proximal link portion 320 at a second linkage joint 330. The first linkage joint 326 allows first control arm 322 to pivot about a first linkage joint axis 328. The second linkage joint 330 allows second control arm 324 to pivot about a second linkage joint axis 332. In the embodiment of FIG. 4, second linkage joint 330 may be tightened so that friction prevents rotation of second control arm 324 and first control arm 322.

The first control arm 322 and the second control arm 324 support a distal link portion 342 of the stand 300. The distal end of the first control arm 322 is pivotally coupled to the distal link portion 342 at a third linkage joint 334. The distal end of the second control arm 324 is pivotally coupled to the distal link portion 342 at a fourth linkage joint 338. The third linkage joint 334 allows relative rotation between the first control arm 322 and the distal link portion 342. Relative rotation between the first control arm 322 and the distal link portion 342 occurs about a third linkage joint axis 336. The fourth linkage joint 338 allows relative rotation between the second control arm 324 and the distal link portion 342. Relative rotation between the second control arm 324 and the distal link portion 342 occurs about a fourth linkage joint axis 340.

With reference to FIG. 4, it will be appreciated that the position of the camera 20 can be changed by raising and lowering the distal ends of the control arms. The proximal ends of the control arms pivot relative to proximal link portion 320 when the distal ends of the control arms are raised and lowered. In some useful embodiments, first control arm 322, second control arm 324, proximal link portion 320 and distal link portion 342 cooperate to form a parallelogram linkage. When this is the case, a line through the first linkage joint axis 328 and the second linkage joint axis 332 remains generally parallel to a line through the third linkage joint axis 336 and the fourth linkage joint axis 340 as first control arm 322 and second control arm 324 rotate relative to proximal link portion 320 and distal link portion 342.

In the embodiment of FIG. 4, stand 300 includes a distal assembly 344 that provides additional degrees of freedom for positioning and orienting the camera 20. The distal assembly 344 of FIG. 4 includes the distal link portion 342, an adjustment tube 302 and a tube holder 346.

In the embodiment of FIG. 4, the tube holder 346 is pivotally coupled to the distal link portion 342 at a hinge joint 376. The hinge joint 376 allows rotation of the tube holder 346 about an axis 50C. The tube holder 346 defines a lumen 348 that is dimensioned to receive the adjustment tube 302. In FIG. 4, the adjustment tube 302 can be seen extending through lumen 348 of tube holder 346.

In the embodiment of FIG. 4, the adjustment tube 302 supports a mounting bracket 306. In the embodiment of FIG. 4, the mounting bracket 306 supports a camera 20. Stand 300 can be used to place and support the camera 20 in a wide variety of locations and orientations. For example, the camera 20 can be rotated by rotating the adjustment tube 302 about an axis 50B. A knob 354 is fixed to one end of adjustment tube 302. The knob 354 may be grasped in the hand when rotating the adjustment tube 302.

In the embodiment of FIG. 4, the adjustment tube 302 is slidingly received in the lumen 348 defined by the tube holder 346. The sliding engagement between the adjustment tube 302 and the tube holder 346 provides a translational degree of freedom. Accordingly, the adjustment tube 302 can slide relative to the tube holder 346 in a direction parallel to its longitudinal axis. The sliding engagement between the adjustment tube 302 and the tube holder 346 also provides a rotational degree of freedom. Accordingly, the adjustment tube 302 can rotate relative to the tube holder 346 about the longitudinal axis of the adjustment tube 302.

Distal assembly 344 includes a thumb screw 350 that may be used to selectively fix the adjustment tube 302 in a desired position. The thumb screw 350 is received in a threaded hole 352 of the tube holder 346. A position retaining force can be applied to the adjustment tube 302 by rotating the thumb screw so that it's distal end presses against the adjustment tube 302. When the thumb screw 350 is loosened, and not applying a fixing force to adjustment tube 302, the adjustment tube will be free to slide and rotate relative to the tube holder 346.

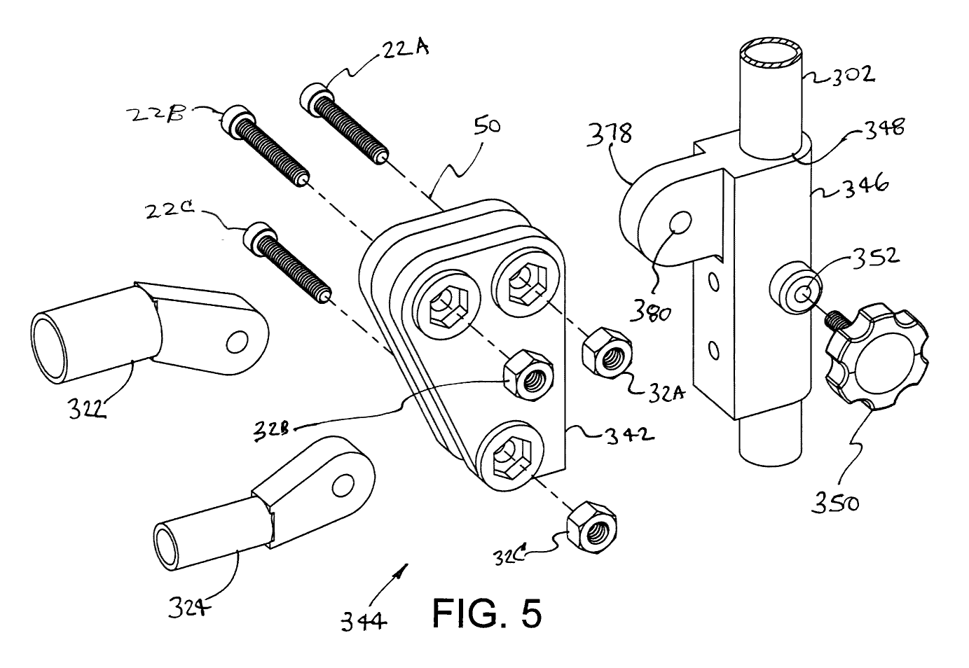

FIG. 5 is an exploded perspective view further illustrating the distal assembly 344 of the stand shown in the previous figure. The distal assembly 344 of FIG. 5 includes the distal link portion 342, an adjustment tube 302 and a tube holder 346. In the embodiment of FIG. 5, the tube holder 346 is pivotally coupled to the distal link portion 342 at a hinge joint formed between the distal link portion 342 and a tab 378 of the tube holder 342. The hinge joint allows rotation of the tube holder 346 about an axis 50.

In the embodiment of FIG. 5, the tab 378 of the tube holder 346 defines a mounting hole 380. The tube holder 346 is pivotally coupled to distal link portion 342 using a screw 22A that extends through the mounting hole 380 defined by the tab 378. The screw 22A mates with a nut 32A.

The distal link portion 342 of the distal assembly 344 is pivotally coupled to a distal portion of the first control arm 322 and a distal portion of the second control arm 324. In the embodiment of FIG. 5, the distal portion of the first control arm 322 is pivotally coupled to the distal link portion 342 using a screw 22B that mates with a nut 32C. The distal portion of the second control arm 324 is pivotally coupled to the distal link portion 342 using another screw 22C that mates with a nut 32C in the embodiment of FIG. 5.

In the embodiment of FIG. 5, the adjustment tube 302 is slidingly received in the lumen 348 defined by the tube holder 346. The sliding engagement between the adjustment tube 302 and the tube holder 346 provides a translational degree of freedom. Accordingly, the adjustment tube 302 can slide relative to the tube holder 346 in a direction parallel to its longitudinal axis. The sliding engagement between the adjustment tube 302 and the tube holder 346 also provides a rotational degree of freedom. Accordingly, the adjustment tube 302 can rotate relative to the tube holder 346 about the longitudinal axis of the adjustment tube 302.

With reference to FIG. 5, it will be appreciated that the distal assembly 344 includes a thumb screw 350 that may be used to selectively fix the adjustment tube 302 in a desired position. The thumb screw 350 is received in a threaded hole 352 of the tube holder 346. A position retaining force can be applied to the adjustment tube 302 by rotating the thumb screw so that it's distal end presses against the adjustment tube 302. When the thumb screw 350 is loosened, and not applying a fixing force to adjustment tube 302, the adjustment tube will be free to slide and rotate relative to the tube holder 346.

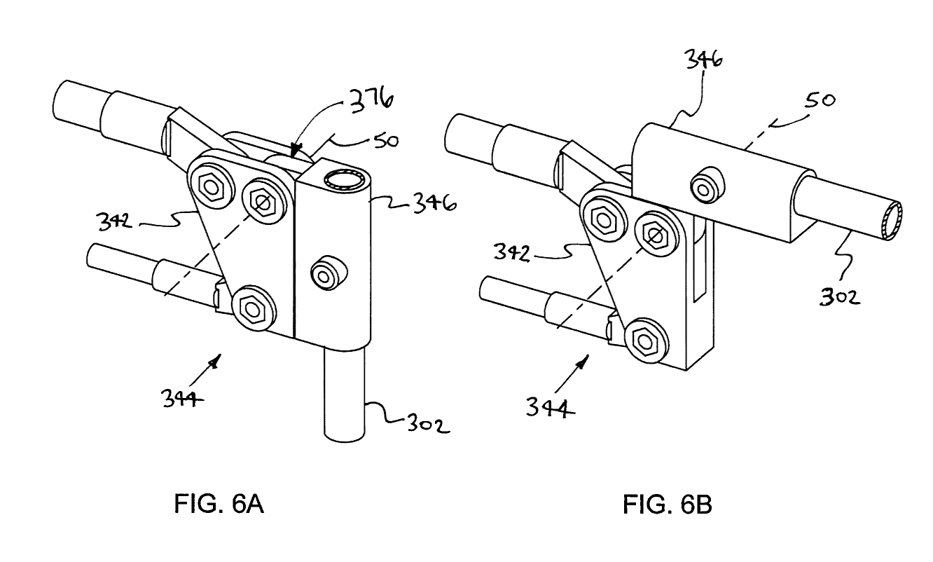

FIG. 6A and FIG. 6B are perspective views showing distal assembly 344 in two different states. FIG. 6A and FIG. 6B may be collectively referred to as FIG. 6. The distal assembly 344 of FIG. 6 includes the distal link portion 342, an adjustment tube 302 and a tube holder 346 In the embodiment of FIG. 6, the tube holder 346 is pivotally coupled to the distal link portion 342 at a hinge joint 376. The hinge joint 376 allows rotation of the tube holder 346 about an axis 50. The tube holder 346 is shown in a first position in FIG. 6A and the tube holder 346 is shown in a second position in FIG. 6B. With reference to FIG. 6, it will be appreciated that the tube holder 346 may be rotated from the first position to the second position. The tube holder 346 may also be rotated from the first position to the second position.

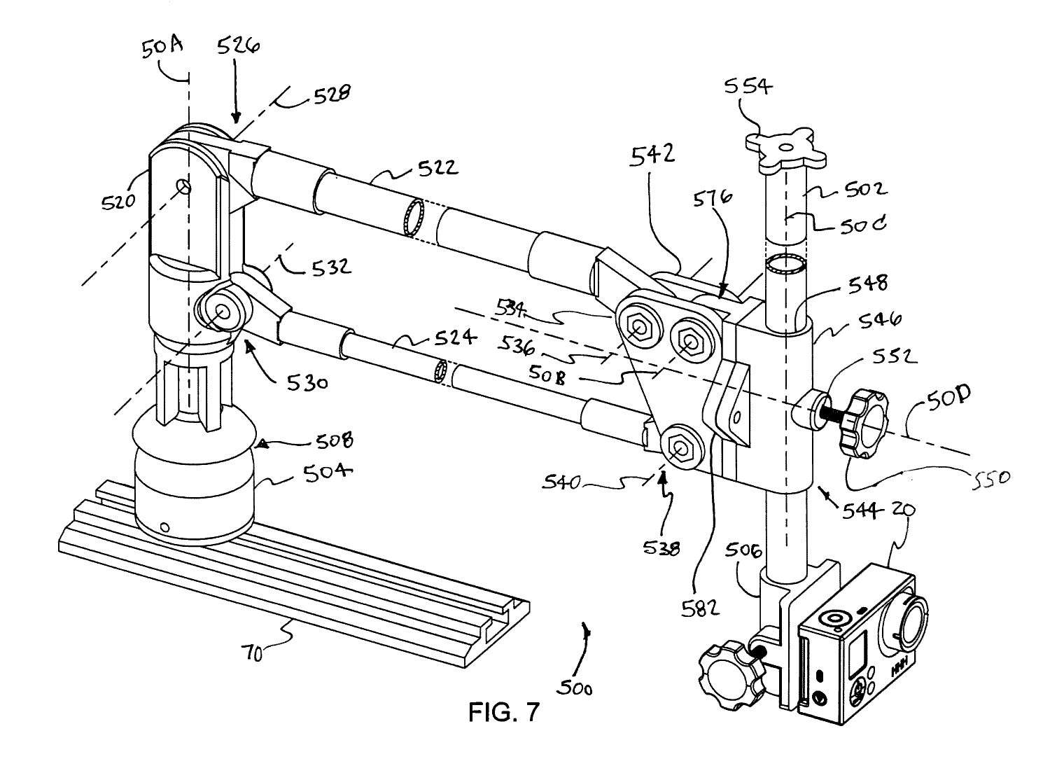

FIG. 7 is an isometric view of a stand 500 that may be used to place and hold a camera 20 in a wide variety of locations and orientations within a space having three dimensions. In the embodiment of FIG. 7, stand 500 includes a base assembly 504 that is fixed to a mounting rail 70. In some useful embodiments, base assembly 504 may be fixed to mounting rail 70 at various positions along a generally T-shaped slot in the mounting rail 70. In the embodiment of FIG. 7, the base assembly 504 includes a pivoting joint 508 that provides three rotational degrees of freedom. The pivoting movement provided by the pivoting joint 508 can be used to alter the position and orientation of the camera 20.

The base assembly 504 includes a proximal link portion 520 that may be selectively rotated about an axis 50A. Proximal link portion 520 supports a first control arm 522 and a second control arm 524 of the stand 500. The proximal end of the first control arm 522 is pivotally coupled to the proximal link portion 520 at a first linkage joint 526. The proximal end of the second control arm 524 is pivotally coupled to the proximal link portion 520 at a second linkage joint 530. The first linkage joint 526 allows first control arm 522 to pivot about a first linkage joint axis 528. The second linkage joint 530 allows second control arm 524 to pivot about a second linkage joint axis 532. In the embodiment of FIG. 7, second linkage joint 530 may be tightened so that friction prevents rotation of second control arm 524 and first control arm 522.

The first control arm 522 and the second control arm 524 support a distal link portion 542 of the stand 500. The distal end of the first control arm 522 is pivotally coupled to the distal link portion 542 at a third linkage joint 534. The distal end of the second control arm 524 is pivotally coupled to the distal link portion 542 at a fourth linkage joint 538. The third linkage joint 534 allows relative rotation between the first control arm 522 and the distal link portion 542. Relative rotation between the first control arm 522 and the distal link portion 542 occurs about a third linkage joint axis 536. The fourth linkage joint 538 allows relative rotation between the second control arm 524 and the distal link portion 542. Relative rotation between the second control arm 524 and the distal link portion 542 occurs about a fourth linkage joint axis 540.

With reference to FIG. 7, it will be appreciated that the position of the camera 20 can be changed by raising and lowering the distal ends of the control arms. The proximal ends of the control arms pivot relative to proximal link portion 520 when the distal ends of the control arms are raised and lowered. In some useful embodiments, first control arm 522, second control arm 524, proximal link portion 520 and distal link portion 542 cooperate to form a parallelogram linkage. When this is the case, a line through the first linkage joint axis 528 and the second linkage joint axis 532 remains generally parallel to a line through the third linkage joint axis 536 and the fourth linkage joint axis 540 as first control arm 522 and second control arm 524 rotate relative to proximal link portion 520 and distal link portion 542.

In the embodiment of FIG. 7, stand 500 includes a distal assembly 544 that provides additional degrees of freedom for positioning and orienting the camera 20. The distal assembly 544 of FIG. 7 includes the distal link portion 542, a flange 582, an adjustment tube 502 and a tube holder 546. In the embodiment of FIG. 7, the flange 582 is pivotally coupled to the distal link portion 542 at a hinge joint 576. The hinge joint 576 allows rotation of the flange 582 about an axis 50B. The flange 582 of distal assembly 544 supports the tube holder 546. In the embodiment of FIG. 7, the connection between the flange 582 and the tube holder 546 provides for indexed rotation of the tube holder about an axis 50D.

The tube holder 546 defines a lumen 548 that is dimensioned to receive the adjustment tube 502. In FIG. 7, the adjustment tube 502 can be seen extending through lumen 548 of tube holder 546. In the embodiment of FIG. 7, the adjustment tube 502 supports a mounting bracket 506. In the embodiment of FIG. 7, the mounting bracket 506 supports a camera 20.

Stand 500 can be used to place and support the camera 20 in a wide variety of locations and orientations. For example, the camera 20 can be rotated by rotating the adjustment tube 502 about an axis 50C. A knob 554 is fixed to one end of adjustment tube 502. The knob 554 may be grasped in the hand when rotating the adjustment tube 502.

In the embodiment of FIG. 7, the adjustment tube 502 is slidingly received in the lumen 548 defined by the tube holder 546. The sliding engagement between the adjustment tube 502 and the tube holder 546 provides a translational degree of freedom. Accordingly, the adjustment tube 502 can slide relative to the tube holder 546 in a direction parallel to its longitudinal axis. The sliding engagement between the adjustment tube 502 and the tube holder 546 also provides a rotational degree of freedom. Accordingly, the adjustment tube 502 can rotate relative to the tube holder 546 about the longitudinal axis of the adjustment tube 502.

Distal assembly 544 includes a thumb screw 550 that may be used to selectively fix the adjustment tube 502 in a desired position. The thumb screw 550 is received in a threaded hole 552 of the tube holder 546. A position retaining force can be applied to the adjustment tube 502 by rotating the thumb screw so that it's distal end presses against the adjustment tube 502. When the thumb screw 550 is loosened, and not applying a fixing force to adjustment tube 502, the adjustment tube will be free to slide and rotate relative to the tube holder 546.

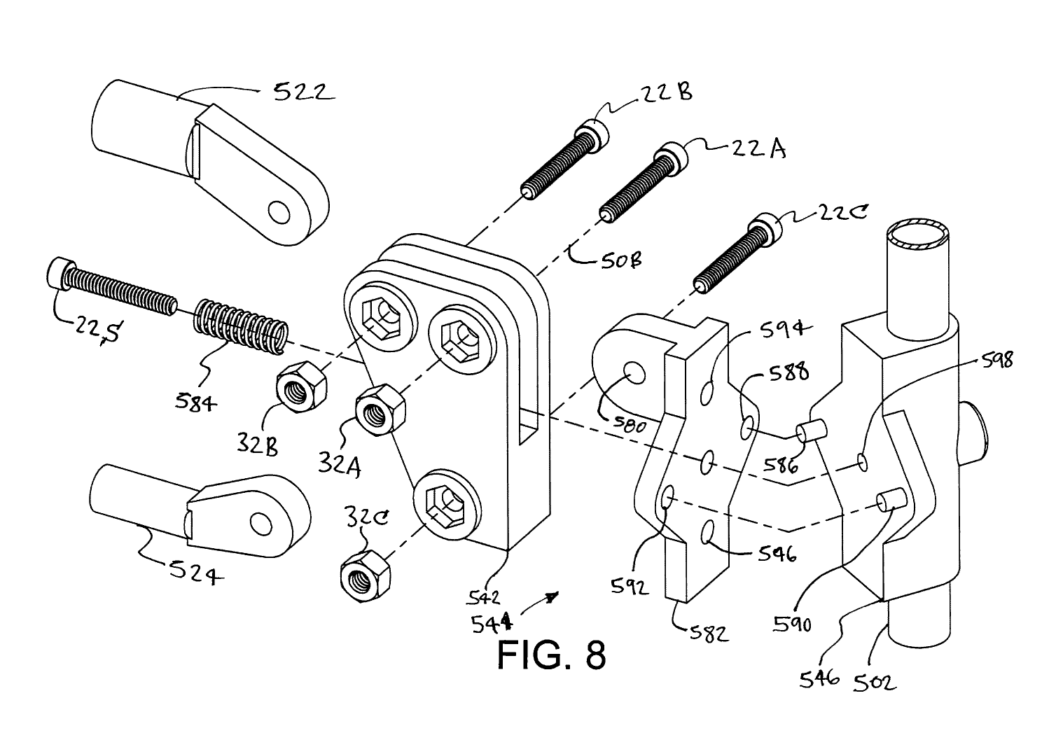

FIG. 8 is an exploded perspective view further illustrating the distal assembly 544 of the stand shown in the previous figure. The distal assembly 544 of FIG. 8 includes the distal link portion 542, a flange 582, an adjustment tube 502 and a tube holder 546 In the embodiment of FIG. 8, the flange 582 is pivotally coupled to the distal link portion 542 at a hinge joint formed between the distal link portion and a tab 578 of the flange. The hinge joint 576 allows rotation of the flange 582 about an axis 50B.

In the embodiment of FIG. 8, the tab 578 of the flange 582 defines a mounting hole 580. The flange 582 is pivotally coupled to distal link portion 542 using a screw 22A that extends through the mounting hole 580 defined by the tab 578. The screw 22A mates with a nut 32A. The flange 582 of distal assembly 544 supports the tube holder 546. In the embodiment of FIG. 8, the connection between the flange 582 and the tube holder 546 provides for indexed rotation of the tube holder about an axis 50D.

With reference to FIG. 8, it will be appreciated that flange 582 defines a first alignment hole 588 and a second alignment hole 592. Tube holder 546 includes a first alignment pin 586 and a second alignment pin 590 that are configured to selectively mate with the alignment holes defined by the flange 582.

The embodiment of FIG. 8 provides for continuous adjustable rotation between the tube holder 546 and the flange 582. In some useful embodiments, the distal assembly 544 includes a mechanism for biasing the tube holder 546 and the flange 582 toward one another. The distal assembly 544 of FIG. 8 includes a spring 584 that will bias the tube holder 546 to seat against the flange 582 when the distal assembly 544 is in an assembled state. The tube holder 546 can be selectively separated from the flange 582 by grasping the tube holder 546 and pulling it away from the flange 582. The spring 584 will be elastically compressed when the tube holder 546 is pulled away from the flange 582. When distal assembly 544 is in the assembled state, a screw 22S extends through the spring 584, through a hole in the flange 582 and engages a threaded hole 598 in the tube holder 546.

When the tube holder 546 is pulled away from the flange 582, the tube holder 546 can be rotated between a first orientation and a second orientation. When the tube holder is in the first orientation, the first alignment pin 586 will be received in the first alignment hole 588 and the second alignment pin 590 will be received in the second alignment hole 592. When the tube holder is in the second orientation, the first alignment pin 586 will be received in a third alignment hole 594 and the second alignment pin 590 will be received in a fourth alignment hole 596.

The distal link portion 542 of the distal assembly 544 is pivotally coupled to a distal portion of the first control arm 522 and a distal portion of the second control arm 524. In the embodiment of FIG. 8, the distal portion of the first control arm 522 is pivotally coupled to the distal link portion 542 using a screw 22B that mates with a nut 32B. The distal portion of the second control arm 524 is pivotally coupled to the distal link portion 542 using another screw 22C that mates with a nut 32C in the embodiment of FIG. 8.

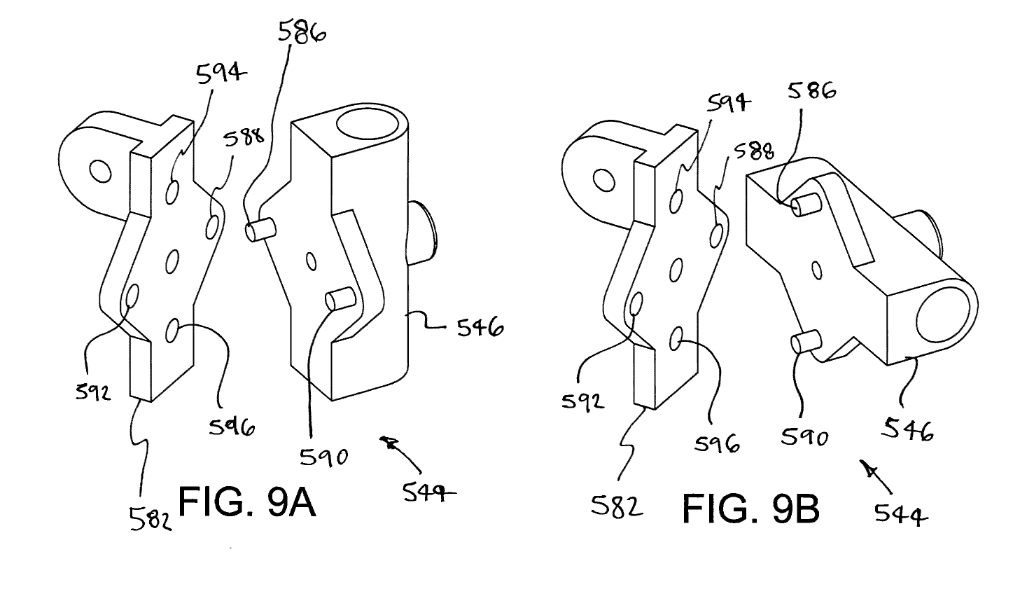

FIG. 9A is an exploded perspective view showing the tube holder 546 and the flange 582 of the distal assembly 544 arranged in a first indexed orientation. FIG. 9B is an exploded perspective view showing the tube holder 546 and the flange 582 arranged in a second indexed orientation. FIG. 9A and FIG. 9B may be collectively referred to as FIG. 9.

With reference to FIG. 9A, it will be appreciated that flange 582 defines a first alignment hole 588, a second alignment hole 592, a third alignment hole 594, and a fourth alignment hole 596. Tube holder 546 includes a first alignment pin 586 and a second alignment pin 590 that are configured to selectively mate with the alignment holes defined by the flange 582.

In the embodiment of FIG. 9A, the first alignment pin 586 is received in the first alignment hole 588 and the second alignment pin 590 is received in the second alignment hole 592 when the distal assembly is an assembled state.

In the embodiment of FIG. 9B, the first alignment pin 586 is received in the third alignment hole 594 and the second alignment pin 590 is received in the fourth alignment hole 596 when the distal assembly is an assembled state.

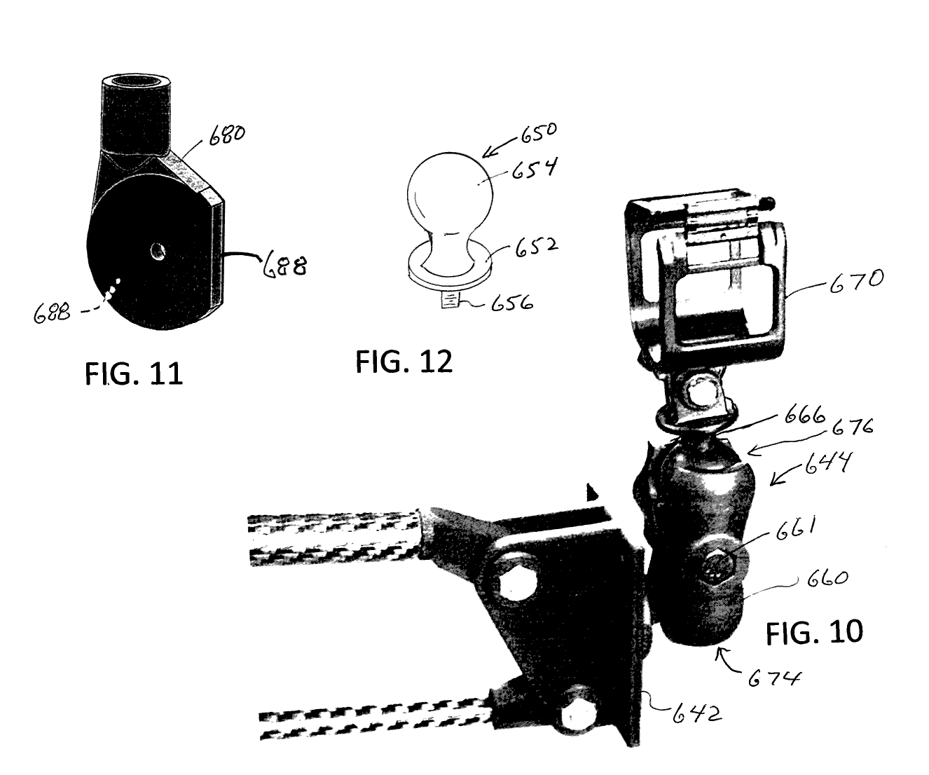

Referring to FIGS. 10-12, another embodiment with a distal link portion 642 and a distal assembly 644 is illustrated. The distal link portion 642 has a ball joint component 650 having a flange portion 652 and a ball portion 654, and a threaded member 656, attached thereto. A clam shell articulating portion 660 with clam shell halves 662 as joint components captures the ball portion 654 and also captures another ball portion of another ball joint component 666 that is attached to cage camera mount 670. The clam shell articulating portion 660 may have a threaded member 661 that can be adjustably tightened for controlling the “tightness” of the joints 674, 676.

Referring to FIGS. 3B, 11 and 12, the joint components 160, 650, 680 have cooperating surfaces that are parallel to cooperating surfaces on a cooperating joint component. An outer surface 688 may be part of an overmolded covering of a polymer providing a high coefficient of friction when engaged with the respective cooperating joint component. The overmolded covering may be on one or both of the cooperating joint components. A threaded member 661 may be utilized to control the clamping force between the cooperating joint components thereby adjusting the resistance of the joint to movement.

The invention is not restricted to the details of the foregoing embodiments. The invention extends to any novel one, or any novel combination, of the features disclosed in this specification (including any incorporated by reference references, any accompanying claims, abstract and drawings), or to any novel one, or any novel combination, of the steps of any method or process so disclosed The above references in all sections of this application are herein incorporated by references in their entirety for all purposes.

Although specific examples have been illustrated and described herein, it will be appreciated by those of ordinary skill in the art that any arrangement calculated to achieve the same purpose could be substituted for the specific examples shown. This application is intended to cover adaptations or variations of the present subject matter. Therefore, it is intended that the invention be defined by the attached claims and their legal equivalents, as well as the following illustrative aspects. The above described aspects embodiments of the invention are merely descriptive of its principles and are not to be considered limiting. Further modifications of the invention herein disclosed will occur to those skilled in the respective arts and all such modifications are deemed to be within the scope of the invention.

What is claimed is:

1. A camera stand comprising a base portion for securement on a support, and a linkage for extending and positioning the camera horizontally from the base portion, the linkage comprising a four bar linkage with a proximal link portion pivotally mounted to the base portion, a pair of parallel control arms extending from the proximal link portion to the distal link portion, the distal link portion having a tube holding portion with a tube extending therethrough, the tube slidable and rotatable adjustable therein, the camera stand further having a camera mount attached to the tube, linkage foldable to a collapsed portion with the tube laying parallel to and along the pair of parallel control arms.

2. The camera stand of claim 1 wherein the proximal link portion and the distal link portion are connected to pair of parallel control arms at four joints, each joint having a pair of cooperating joint portions with cooperating interfacing joint portions, the cooperating interfacing joint portions having a pair of parallel cooperating surfaces, wherein at least one of cooperating interfacing joint portions comprising a base portion with an overmolded polymer exterior layer, the layer defining one of the parallel cooperating surfaces, the overmolded polymer exterior layer having a durometer in the range of 60 to 80 on the Shore D scale.

3. The camera stand of claim 1 wherein the four bar linkage comprises a proximal link portion with two joints positioned thereon, the proximal link portion rotatable about the base portion about a vertical axis.

4. The camera stand of claim 2, wherein the proximal link portion has the overmolded polymer layer.

5. The camera stand of claim 3, wherein the proximal link portion has at least three joint holes providing alternate positioning capability for the two joints defined thereon.

6. The camera stand of claim 2 wherein the at least one of cooperating interfacing joint portions comprising a base portion with an overmolded polymer exterior layer is positioned on the proximal link portion.

7. The camera stand of claim 6 wherein the at least on joint has a threaded member with a manually graspable handle thereon for adjusting a clamping force at the at least one joint.

8. The camera stand of claim 1 wherein the pair of elongate parallel arms are each of the same length intermediate the respective joints.

9. The camera stand of claim 40 wherein the tube holder further comprises a threaded member with a manually graspable handle for adjusting clamping pressure on the tube by the distal link portion.

10. A camera stand comprising a base portion for securement on a support, and a linkage for extending and positioning the camera at least three feet horizontally from the base portion, the linkage comprising a plurality of link arms interconnected at a plurality of joints, the plurality of link arms defining a four bar linkage, the camera stand further having a camera mount at a distal end of the linkage;
wherein each joint having a pair of cooperating joint portions with cooperating interfacing joint portions, the cooperating interfacing joint portions having a pair of parallel cooperating surfaces, wherein at least one of cooperating interfacing joint portions comprising a base portion with an overmolded polymer exterior layer, the layer defining one of the parallel cooperating surfaces, the overmolded polymer exterior layer having a durometer in the range of 65 to 75 on the Shore D scale.

11. The camera stand of claim 10 wherein the four bar linkage comprises a proximal link portion with two joints positioned thereon, the proximal link portion rotatable about the base portion about a vertical axis.

12. The camera stand of claim 11, wherein the proximal link portion has the overmolded polymer layer.

13. The camera stand of claim 11, wherein the proximal link portion has at least three joint holes providing alternate positioning capability for the two joints defined thereon.

14. The camera stand of claim 11 wherein the at least one of cooperating interfacing joint portions comprising a base portion with an overmolded polymer exterior layer is positioned on the proximal link portion.

15. The camera stand of claim 14 wherein the at least on joint has a threaded member with a manually graspable handle thereon for adjusting a clamping force at the at least one joint.

16. The camera stand of claim 10 further comprising a distal link portion interconnected to the proximal link portion by a pair of elongate parallel arms, the distal link portion having two joints positioned thereon.

17. The camera stand of claim 16 wherein the pair of elongate parallel arms are each of the same length.

18. The camera stand of claim 10, wherein the four bar linkage comprises a proximal link portion and a distal link portion, two parallel control arms extending between the proximal link portion and distal link portion from two joints on the proximal link portion to two links on the distal link portion.

19. The camera stand of claim 18 wherein the distal link portion comprises a tube holder portion with a lumen extending in an upright direction and the camera stand further comprises a tube slidingly and rotatable received in the lumen, and wherein the camera mount is attached to the tube.

20. A camera stand for positioning, orienting and supporting a camera, comprising:
a base portion for anchoring or seating a proximal link portion supporting a first control arm and a second control arm, a proximal end of the first control arm being pivotally coupled to the proximal link portion at a first linkage joint and a proximal end of the second control arm being pivotally coupled to the proximal link portion at a second linkage joint;
a distal link portion supported by the first control arm and the second control arm, a distal end of the first control arm being pivotally coupled to the distal link portion at a third linkage joint and the distal end of the second control arm being pivotally coupled to the distal link member at a fourth linkage joint;
a tube holder fixed to the distal link portion;
an adjustment tube slidingly received in a lumen defined by the tube holder; and
a locking mechanism for selectively locking a position of the adjustment tube relative to the tube holder, the locking mechanism having a locked state and an unlocked state, the adjustment tube being free to slide relative to the tube holder in a direction parallel to a longitudinal axis of the adjustment tube when the locking mechanism is in the unlocked state, and the adjustment tube being free to rotate relative to the tube holder about the longitudinal axis of the adjustment tube when the locking mechanism is in the unlocked state.
